(19) United States
(12) Patent Application Publication
(10) Pub. No.: US 2008/0120650 A1
(43) Pub. Date: May 22, 2008

(54) PROGRAM INFORMATION PROVIDING SYSTEM

(75) Inventors: Ryohei Orihara, Tokyo (JP); Kouichirou Mori, Saitama-shi (JP); Tomoko Murakami, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/943,135

(22) Filed: Nov. 20, 2007

(30) Foreign Application Priority Data
Nov. 21, 2006 (JP) P2006-314072

(51) Int. Cl. G06F 3/00

(52) U.S. Cl. 725/45

(57) ABSTRACT

A program information providing system includes: a genre selecting unit that selects a selected program genre from among a plurality of program genres contained in program information based on a selection criterion obtained from frequency information that indicates frequencies of each of the program genres during a predetermined time period; a preference model generating unit that generates a preference model describing a causal relationship between a cause leading to a viewing and a viewed result, based on the selected program genre and viewing history information of the viewer; and a recommended program list generating unit that generates a recommended program list by using the preference model generated by the preference model generating unit.

### RELATED APPLICATION(S)

The present disclosure relates to the subject matter contained in Japanese Patent Application No. 2006-314072 filed on Nov. 21, 2006, which is incorporated herein by reference in its entirety.

### FIELD

The present invention relates to a program information providing system, a method for providing program information, and a computer readable program product for providing program information that provides program information.

### BACKGROUND

Recently, the trend toward multi-channel of the digital broadcasting, such as CATV, CS broadcasting, and digital terrestrial broadcasting, is growing, and video contents are massively distributed. In such situation, even the operation for selecting the program to watch TV becomes complicated. Therefore, much attention is now focused on a service for selecting and recommending a program that suits a viewer's preference from an enormous number of programs. For example, technologies related to the program recommendation are proposed as follows.

(1) Program Search Based on Attributes of Programs Previously Viewed

Programs are respectively represented by vectors indicating various attributes that characterize the programs, and all programs are arranged in a vector space. Based on the attributes of the programs previously viewed, similar programs are searched and recommended to a viewer by calculating a Euclidean distance over the vector space. However, according to this technology, the program search does not function well unless a viewing history of the viewer is satisfactorily accumulated.

Examples of this technology are disclosed in:

JP-A-7-135621; and

JP-A-10-032797.

(2) Recommendation of the Viewing Program Based on the Classifying Model

A model for classifying the programs previously viewed and not viewed is learned while using information indicating whether the viewer viewed or not viewed each of the programs as a supervising signal. A prediction on the programs to be broadcasted in the future to be viewed or not viewed by the viewer is performed based on the learned model, and the programs that are predicted to be viewed are recommended to the viewer. However, according to this technology, although a rough tendency of the viewer on the previous programs that the viewer has viewed or not viewed becomes clear, it is difficult to learn the viewer's rare viewing tendency.

Examples of this technology are disclosed in:

JP-A-2000-333085; and

JP-A-2001-160955 (also published as US 2001/0049822 A1).

(3) Program Recommendation Based on the Viewer's Feature

While using the information grouped based on the program feature (e.g., program genre) as an objective variable and using the features of the viewer (e.g., age, sex) as a predictor variable, features of the viewers who viewed the programs and belonging to the same group are learned. The programs to be broadcasted in the future are recommended based on the learned model and the viewer's feature. However, according to this technology, although the preference for the viewing of the viewer group becomes clear, it is difficult to recommend a program that suits the preference of an individual viewer.

An example of this technology is disclosed in:

M. J. Pazzani: A Framework for Collaborative, Content-Baseband Demographic Filtering, Journal of Artificial Intelligence Review, Vol. 13, No. 5-6, pp. 393. 408, (1999).

(4) Setting/Recording Function by Cooperative Filtering

Based on the viewing history of a particular viewer A, a viewer B having the similar viewing tendency is selected from among a plurality of viewers. The programs viewed by the viewer B are recommended to the viewer A. However, according to this technology, the setting/recording function does not function well unless a lot of viewers are sampled and another viewer who has a preference similar to a particular viewer exists. It is also difficult to handle a new program in which no viewing history is accumulated.

An example of this technology is disclosed in:

JP-A-2003-114903 (also published as US 2003/0088871 A1).

(5) Program Recommendation Based on the Learning of the Viewer's Behavior Pattern

A terminal of a viewer detects an affirmative operation and a negative operation made by the viewer in enjoying the contents, classifies the detected operations on time zone the operation is made and on a day basis of the week, and generates statistic data for learning the viewer's behavior pattern. The terminal searches the contents that the viewer might like to view based on the viewer's behavior pattern in a self-controlled manner, and recommends the searched contents to the viewer. The terminal updates the viewer's behavior pattern based on the Bayes' theorem and learns the viewer's behavior pattern. However, according to this technology, the viewer's profile information and the affirmative/negative operation must be input by the viewer.

An example of this technology is disclosed in:

JP-A-2004-206445.

Other than the above-described technologies, there is proposed a program assisting system that calculates a viewing score from an analysis table of viewed elements, such as genre, based on the viewing history of the viewer, analyzes a viewing tendency of the viewer, and presents a program based on the viewing tendency. However, according to this technology, it is difficult to present a program when an amount of accumulation of the viewing history is small.

An example of this technology is disclosed in:

JP-A-2000-013708 (also published as U.S. Pat. No. 7,096,486 B1 and US 2006/0271958 A1).

Also, in ARIB (Association of Radio Industries and Business) operation regulation (TR-B14), three genres may be correlated with one program, but no rule is given of ordering and meaning when plural genres are correlated. Therefore, when a plurality of genres are correlated with one program, it is not clear which one should be used for advantageously learning the preference of the viewer. Also, a case where plural genres are correlated with each of the programs is a relatively rare case. Therefore, correlation of the preference model with plural genres makes the model unnecessarily complicated and is disadvantageous in a respect of computational speed.

The document JP-A-2000-013708 discloses importing plural genres explicitly as the preference element. But merely a simple model can be learned because independence between the preference elements must be assumed.

One of the inventors of the present invention has filed a patent application that discloses a program information providing system that generates a preference model while considering the genre based on the viewing history of the viewer and generates and presents a recommended program list. The patent application is published as JP-A-2007-060398 (counterpart U.S. application is filed as: application Ser. No. 11/509,014).

However, in the system disclosed in the patent application JP-A-2007-060398, it is not clear how the genre should be selected from plural genres when plural genres are recited in the program information.

### SUMMARY

According to a first aspect of the invention, there is provided a program information providing system including: a genre selecting unit that selects a selected program genre from among a plurality of program genres contained in program information based on a selection criterion obtained from frequency information that indicates frequencies of each of the program genres during a predetermined time period; a preference model generating unit that generates a preference model describing a causal relationship between a cause leading to a viewing and a viewed result, based on the selected program genre and viewing history information of the viewer; and a recommended program list generating unit that generates a recommended program list by using the preference model generated by the preference model generating unit.

According to a second aspect of the invention, there is provided a program information providing system including: a genre selecting unit that selects a selected program genres from among a plurality of program genres contained in program information based on a selection criterion obtained from an order of appearance of the program genre in the program information; a preference model generating unit that generates a preference model describing a causal relationship between a cause leading to a viewing and a viewed result, based on the selected program information and viewing history information of the viewer; and a recommended program list generating unit that generates a recommended program list by using the preference model generated by the preference model generating unit.

According to a third aspect of the invention, there is provided a method for providing program information, the method including: selecting, when a plurality of program genres are contained in program information, a selected program genre from among the program genres based on a selection criterion obtained from frequency information that indicates frequencies of each of the program genres during a predetermined time period; generating a preference model that describes a causal relationship between a cause leading to a viewing and a viewed result, based on the selected program genre and viewing history information of the viewer; and generating a recommended program list by using the preference model generated by the preference model generating unit.

According to a fourth aspect of the invention, there is provided a method for providing program information, the method including: selecting, when a plurality of program genres are contained in program information, a selected program genre from among the program genres based on a selection criterion obtained from an order of appearance of the program genre in the program information; generating a preference model that describes a causal relationship between a cause leading to a viewing and a viewed result, based on the selected program genre and viewing history information of the viewer; and generating a recommended program list by using the preference model generated by the preference model generating unit.

According to a fifth aspect of the invention, there is provided a computer-readable medium containing a program for causing a computer system to operate to perform a process including: selecting, when a plurality of program genres are contained in program information, a selected program genre from among the program genres based on a selection criterion obtained from frequency information that indicates frequencies of each of the program genres during a predetermined time period; generating a preference model that describes a causal relationship between a cause leading to a viewing and a viewed result, based on the selected program genre and viewing history information of the viewer; and generating a recommended program list by using the preference model generated by the preference model generating unit.

According to a sixth aspect of the invention, there is provided a computer-readable medium containing a program for causing a computer system to operate to perform a process including: selecting, when a plurality of program genres are contained in program information, a selected program genre from among the program genres based on a selection criterion obtained from an order of appearance of the program genre in the program information; generating a preference model that describes a causal relationship between a cause leading to a viewing and a viewed result, based on the selected program genre and viewing history information of the viewer; and generating a recommended program list by using the preference model generated by the preference model generating unit.

### BRIEF DESCRIPTION OF THE DRAWINGS

In the accompanying drawings:

FIG. 1 is a view showing a schematic configuration of a program information providing system according to an embodiment of the present invention;

FIG. 2 is a view showing an exemplary configuration of a genre selecting unit shown in FIG. 1;

FIG. 3 is a flowchart showing a flow of processes of generating a preference model;

FIG. 4 is a view showing an example of the preference model;

FIG. 5 is a view showing an example of a configuration of a Bayesian network described in a computer-readable format in the preference model shown in FIG. 4;

FIG. 6 is a view showing an example of television program information (EPG: Electronic Program Guide) to be processed in the embodiment;

FIG. 7 is a view showing viewing history information of a viewer of the television program information shown in FIG. 5;

FIG. 8 is a view showing an example of a conditional probability table calculated and output in the embodiment in compliance with the preference model shown in FIG. 4;

FIG. 9 is a flowchart showing procedures of generating a recommended program list to provide program information that suits the viewer's preference;

FIG. 10 is a view showing an example of the number of broadcasted times of the broadcasting programs in one week every genre;

FIG. 11 is a flowchart showing procedures of generating a recommended program list base on the preference list;

FIG. 12 is a view showing an example of recommended program data generated in the embodiment;

FIG. 13 is a flowchart showing a genre selecting process according to a second embodiment;

FIG. 14 is a view showing a configuration of a genre selecting unit according to a third embodiment;

FIG. 15 is a flowchart showing a genre selecting process according to a fourth embodiment;

FIG. 16 is a flowchart showing a genre selecting process according to a fifth embodiment;

FIG. 17 is a flowchart showing a genre selecting process according to a sixth embodiment;

FIG. 18 is a table showing experimental results according to the second embodiment;

FIG. 19 is a table showing experimental results according to the fourth embodiment; and

FIG. 20 is a table showing differences between the experimental results according to the second embodiment and the experimental results according to the fourth embodiment.

### DETAILED DESCRIPTION OF THE EMBODIMENTS

Referring now to the accompanying drawings, embodiments of the present invention will be described in detail.

In following explanation of the embodiments of the present invention, recommendation of the television program in providing program information will be explained hereinafter while selecting data concerning a television program as an object to be processed. However, the data as the object to be processed is not limited to the data concerning the television program, and the overall broadcasting contents can be widely selected as the object to be processed. Therefore, the advantages of the present invention can be achieved not only in the recommendation of the television program that suits the viewer's preference in the present embodiment but also widely in the broadcasting contents information providing system. Also, in the present invention, a model describing a viewer's preference for program viewing is called a “preference model”.

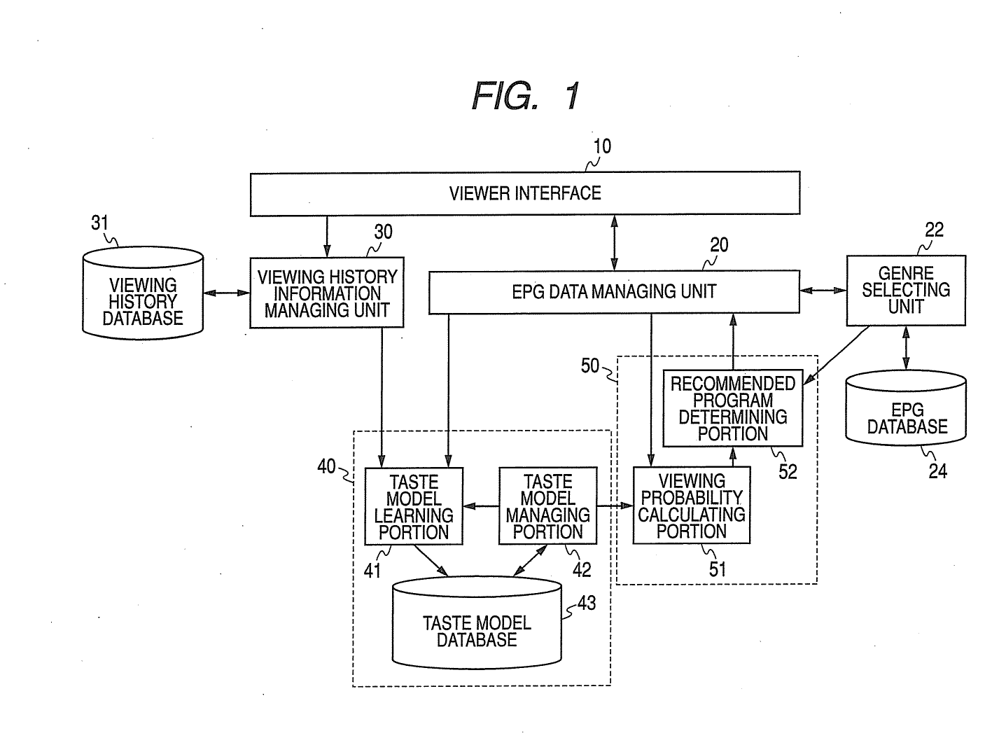

FIG. 1 is a view showing a schematic configuration of a program information providing system according to an embodiment of the present invention.

The program information providing system shown in FIG. 1 includes a viewer interface 10 for holding communication with the external equipment (for example, a TV receiver set or a display device), an EPG data managing unit 20 for receiving program information (EPG: Electronic Program Guide), e.g., television program information, (sometimes referred to as “television program information” hereinafter) from the viewer interface 10 and managing such information, a genre selecting unit 22 for selecting a genre from a plurality of genres based on a predetermined criterion described later, a viewing history information managing unit 30 for receiving viewing history information of the viewer from the viewer interface 10, managing such information, and updating such information periodically, a preference model generating unit 40 for generating a preference model based on the program information and the viewing history information, and a recommended program list generating unit 50 for generating a recommended program list from the preference model made by the preference model generating unit 40 and the program information. The EPG data input into the EPG data managing unit 20 is recorded in an EPG database 24 via the genre selecting unit 22. The viewing history input into the viewing history information managing unit 30 is recorded in a viewing history database 31.

As shown in FIG. 1, the preference model generating unit 40 is provided with: a preference model learning portion 41 for receiving the television program information and the viewing history information of the viewer for a predetermined term in the past as input information from the EPG data managing unit 20 and a viewing history information managing unit 30 respectively and generating the preference model; a preference model managing portion 42 for managing structure defining data and a conditional probability value as the preference model; and a preference model database 43 for recording the preference model made by the preference model learning portion 41.

The preference model learning portion 41 receives new program information and viewing history and updates the preference model periodically or at a point of time when predetermined number of data are input.

The recommended program list generating unit 50 is provided with: a viewing probability calculating portion 51; and a recommended program determining portion 52. The viewing probability calculating portion 51 receives the EPG data input from the EPG data managing unit 20 and the conditional probability value of the preference model input from the preference model managing portion 42, and calculates a viewing probability of the television program broadcasted in the future.

The recommended program determining portion 52 determines the recommended program based on the viewing probability calculated by the viewing probability calculating portion 51. The recommended program determined by the recommended program determining portion 52 is displayed on a display, such as a TV (not shown), for example, via the EPG data managing unit 20 and the viewer interface 10.

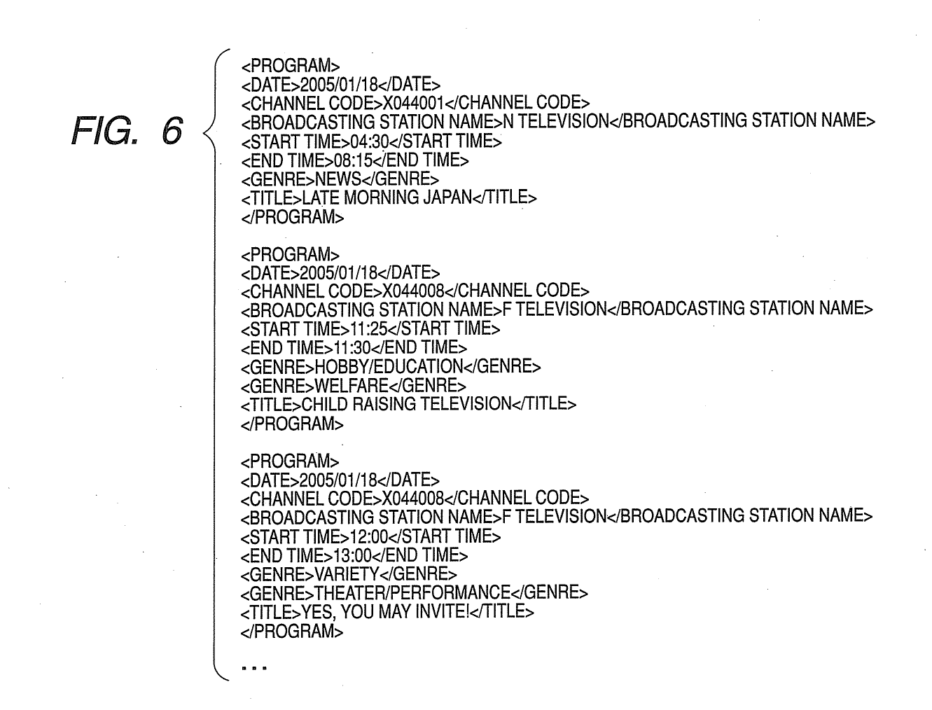

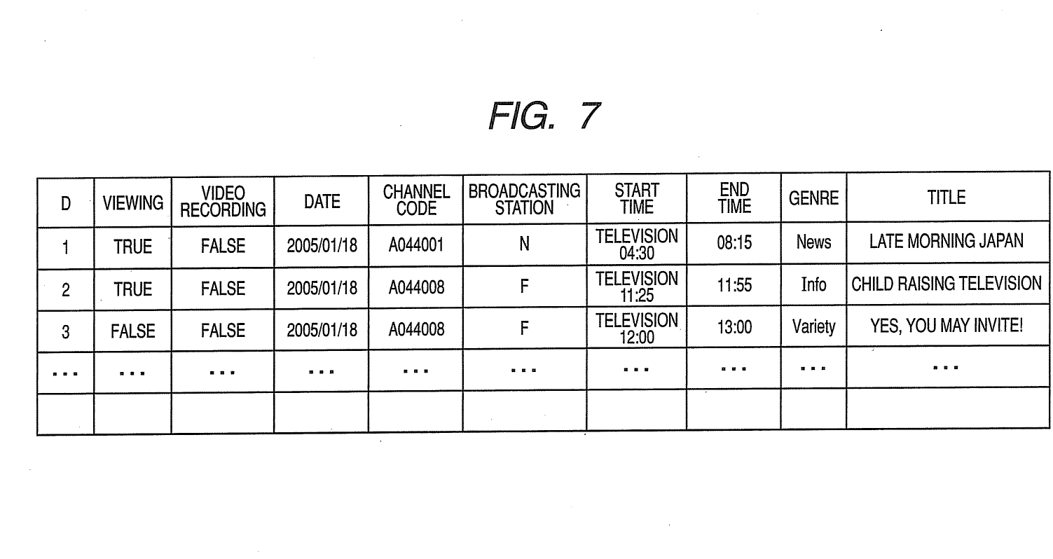

To the viewer interface 10, the television program information (EPG) received from the external broadcasting equipment, and the viewing history obtained by monitoring the viewer's operation of the television receiver set, for example, are input as the input information. The television program information and the viewing history information of the viewer are not limited to the contents described later and shown in FIGS. 6 and 7. The information may have various formats and definitions, and may be input from a keyboard, a remote controller, an on-line network, an information transfer medium such as a magnetic tape, or the like.

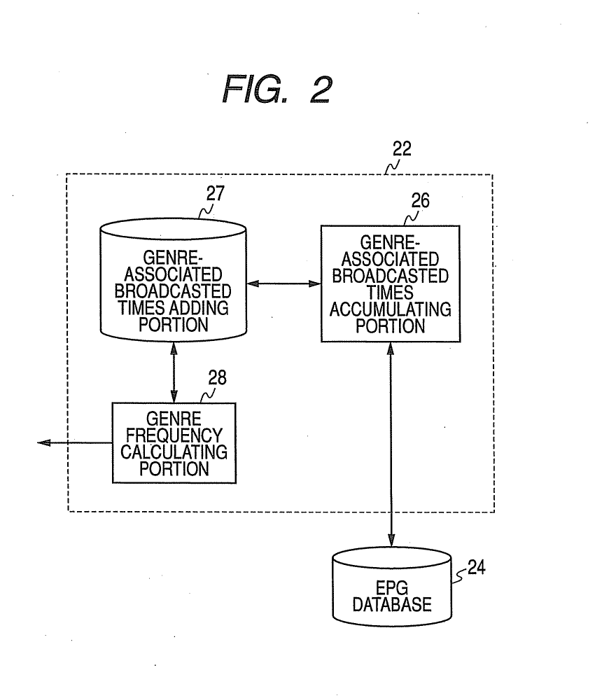

An exemplary configuration of the genre selecting unit 22 is shown in FIG. 2. The genre selecting unit 22 is provided with: a genre-associated broadcasted times accumulating portion 26 for accumulating the number of broadcasted time (frequency) a day every genre from the EPG data read from the EPG database 24; a genre-associated broadcasted times adding portion 27 for accumulating and adding such number every genre over a predetermined term such as one week, one month, or the like; and a genre frequency calculating portion 28 for calculating a genre frequency from the number of broadcasted time stored in the genre-associated broadcasted times adding portion 27 every genre for a predetermined term.

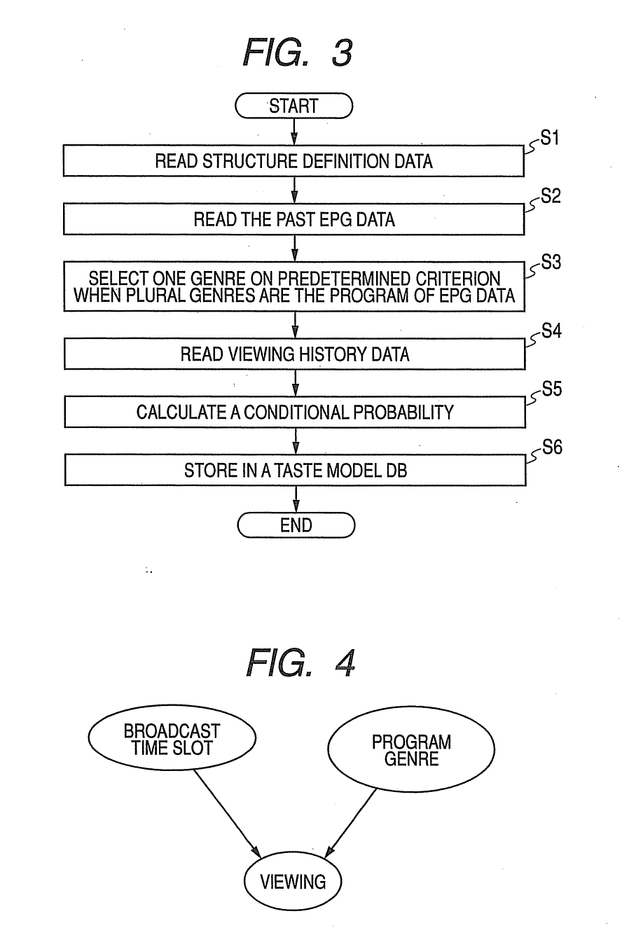

Next, an operation of the program information providing system according to the embodiment will be explained hereunder. First, procedures of generating the preference model will be explained with reference to FIG. 3 as a flowchart showing a flow of generating the preference model.

An example of the preference model is shown in FIG. 4. This example is an example of the preference model selected as the object to be processed in the embodiment.

The preference model as the object to be processed is the model expressed by a Bayesian network. The Bayesian network is the model expressed by a non-periodic directed graph whose link is oriented in the direction of a causal relationship and whose path does not circulate along the link, in the probability network as the probability model given by a graph structure in which a random variable is represented by a node and the link is established between variations having a depending relation such as a causal relationship or a correlation.

The model shown in FIG. 4 is the preference model in which a “broadcast time frame” and a “program genre” are used as the random variable, and also the causal relationship indicating how the “broadcast time frame” and the “program genre” exert an influence on the viewing is described.

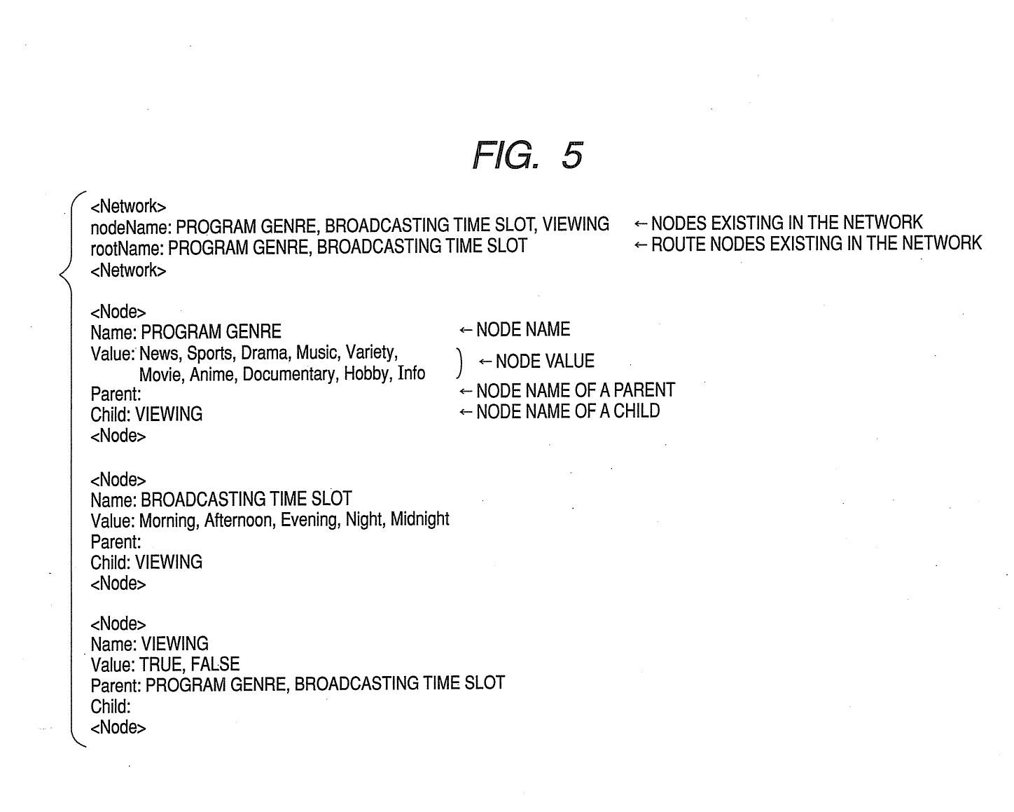

First, in step S1 shown FIG. 3, the preference model learning portion 41 reads structure definition data that defines the structure of the preference model and is shown in FIG. 5. FIG. 5 describes a configuration of a Bayesian network in the preference model shown in FIG. 4 in a computer-readable format.

In FIG. 5, three elements of the “broadcast time frame”, the “program genre”, and the “viewing” are defined as the random variable (Name). Also, in FIG. 5, a value that each random variable has (Value) is defined.

For example, as the value of the random variable “program genre”, ten types of values such as “News”, “Sports”, “Drama”, “Music”, “Variety”, “Movie”, “Anime”, “Documentary”, “Hobby”, and “Info” are given.

Similarly, as the value of the random variable “broadcast time frame”, five types of values such as “Morning”, “Afternoon”, “Evening”, “Night”, and “Midnight” are given. Also, as the value of the random variable “viewing”, two types of values such as “view (TRUE)” and “not view (FALSE)” are given. Also, in order to define the causal relationship, the concerned random variable is recited by setting the random variable serving as a cause as a “parent node (Parent)” and the random variable serving as a result as a “child node (Child)”.

Next, in step S2 shown in FIG. 3, the preference model learning portion 41 reads the television program information for a predetermined term in the past, as shown in FIG. 6, i.e., the viewing history data, from the EPG data managing unit 20.

FIG. 6 shows an example of the television program information (EPG: Electronic Program Guide) as the object to be processed. As shown in FIG. 6, the television program information includes a date, a broadcasting station, start and end times, and a title every program. A cast information may be attached to the television program information as the case may be.

In the example shown in FIG. 6, as the television program on Jan. 18, 2005, “Late morning Japan” is broadcasted on the N television from 4:30 to 8:15, “Child raising television” is broadcasted on the F television from 11:25 to 11:30, and “Yes, you may invite!” is broadcasted on the F television from 12:00 to 13:00.

When plural program genres such as such as “Child raising television” and “Yes, you may invite!” are contained in the television program data shown in FIG. 6, the genre selecting unit 22 decides which genre should be selected, based on predetermined criterion (step S3). The information of the selected program genre is input into the preference model learning portion 41 via the EPG data managing unit 20. The selecting criterion applied when plural program genres are present will be explained in detail later.

After the television program information (EPG) data as shown in FIG. 6 is read in step S2, the preference model learning portion 41 reads the viewing history data collected for a predetermined term in the past, as shown in FIG. 7, from the viewing history information managing unit 30 (step S4). FIG. 7 is a view showing viewing history information of a particular viewer of the television program information in FIG. 6.

In FIG. 7, symbols “TRUE” and “FALSE” are used to indicate the viewing history information of the television program information shown in FIG. 6. Specifically, the viewing or the video recording was executed when the attribute is “TRUE” whereas the viewing or the video recording was not executed when the attribute is “FALSE”.

For example, in FIG. 7, since the programs whose attribute “viewing” is “TRUE” are “Late morning Japan” and “Child raising television”, the viewer has viewed these two programs. In contrast, since the attribute “video recording” of these programs is “FALSE”, the video recording has not been executed. In this case, the viewing history information is the information that is associated with the result that the viewer has actually viewed the program or the viewer has not viewed the program.

In next step S5, the preference model learning portion 41 calculates a conditional probability value of each random variable in the Bayesian network. Then, the preference model learning portion 41 stores this conditional probability value together with the structure defining data as the preference model in the preference model database 43 (step S6).

As the method of calculating the conditional probability value in step S5, a frequency of the program that meets the condition may be calculated from the viewing history information collected for a predetermined term in the past, as shown in FIG. 7, or the system designer may set any value as the conditional probability value.

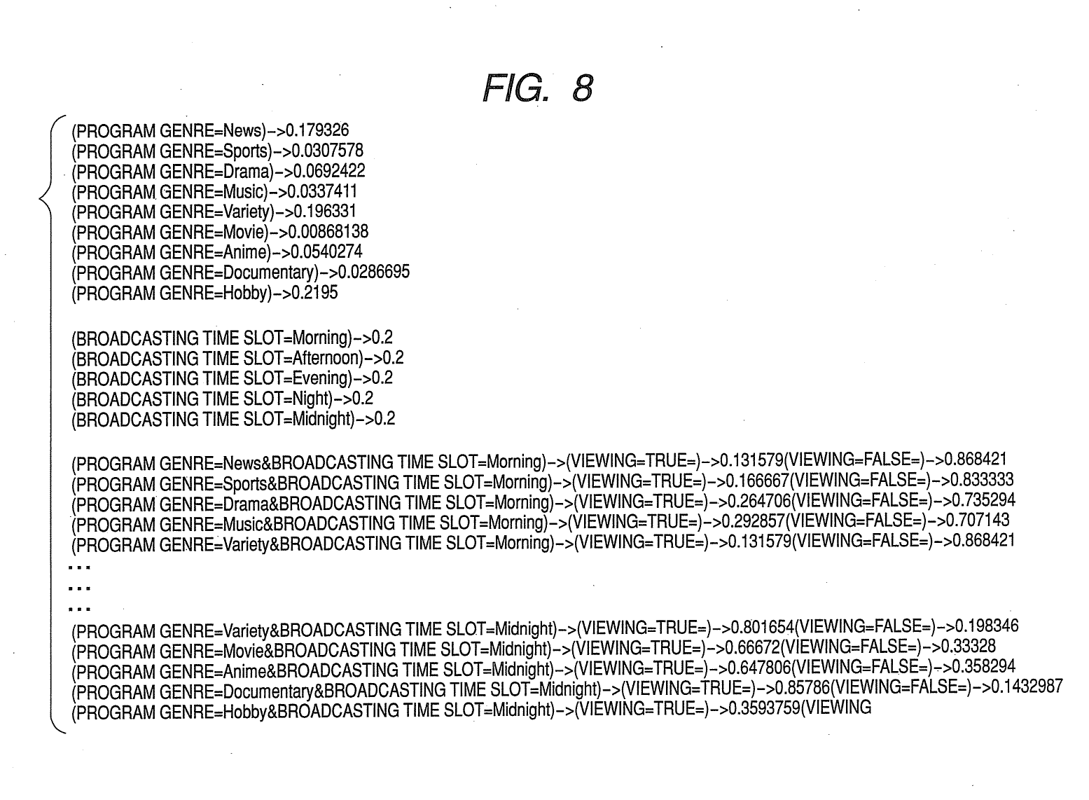

The preference model managing portion 42 manages the structure defining model shown in FIG. 5 and the conditional probability value shown in FIG. 8 as the preference model. FIG. 8 shows an example of a conditional probability table calculated and output in the embodiment of the present invention, in compliance with the preference model shown in FIG. 4.

In the embodiment, the values in the conditional probability table are calculated by using the viewing history of the viewer shown in FIG. 7. However, the system designer or the viewer may set any value in advance.

In FIG. 8, the probability values are defined when the random variable “program genre” takes respective values. For example, the following description on the first row shown in FIG. 8 denotes that the probability value with which the viewer views the news as the program genre is 0.179326.

(Program genre=News)->0.179326

For example, this value can be derived by calculating a frequency of the program, whose random variable “program genre” is “News”, out of all programs contained in the viewing history of the viewer shown in FIG. 6. Similarly, the probability values of various program genres such as “Sports”, “Drama”, etc. are defined in the following. Also, the viewing probability value is defined similarly with regard to the random variable “broadcasting time frame”.

In contrast, the probability value of the random variable “viewing”, when calculated in compliance with the preference model shown in FIG. 4, is affected by the “broadcasting time frame” and the “program genre”. Therefore, the probability value is defined under the condition that all variations of respective values of the “broadcasting time frame” and the “program genre” are taken into consideration. For example, the description on the fifth row from the bottom in FIG. 8 denotes that the probability value with which the program whose “program genre” is “Variety” and whose “broadcasting time frame” is “Midnight” is viewed by the viewer is 0.801654 and the probability value with which the program is not viewed by the viewer is 0.198346.

(program genre=Variety & broadcasting time frame=Midnight)->(viewing=TRUE)->0.801654, (viewing=FALSE)->0.198346

For example, this value can be derived by calculating a frequency of the program out of the programs which are contained in the viewing history of the viewer shown in FIG. 7 and whose random variable “program genre” is “Variety” and whose random variable “broadcasting time frame” is “Midnight”, dependent on whether the random variable “viewing” is true or not.

Here, the genre of the program is important information upon providing the program that suits the viewer's preference.

When there are plural program genres and any one is selected from these genres, the case where a genre frequency is considered by checking a frequency of the programs that are broadcasted actually and the case where a genre is considered from the structure of the television broadcasting program information shown in FIG. 6 may be supposed.

Also, in the former case where a genre frequency is considered, there are the case where the program genre whose frequency is high is preferentially selected, the case where the program genre whose frequency is low is preferentially selected, and the like.

In following embodiments, the overall configuration shown in FIG. 1 and respective processes are common, but the embodiments are different only in a respect of how the program genre should be considered and selected. The configuration of the genre selecting unit 22 shown in FIG. 2 shows the configuration used in Embodiments 1, 2 described hereunder.

### FIRST EMBODIMENT

A first embodiment that selects the program genre having a high frequency when a genre frequency is considered will be described.

In any event, when a genre frequency is considered, such genre frequency must be calculated. Therefore, the number of times of the actual television broadcasting program must be derived every genre. A calculation of the genre frequency in the genre selecting unit 22 will be described as follows.

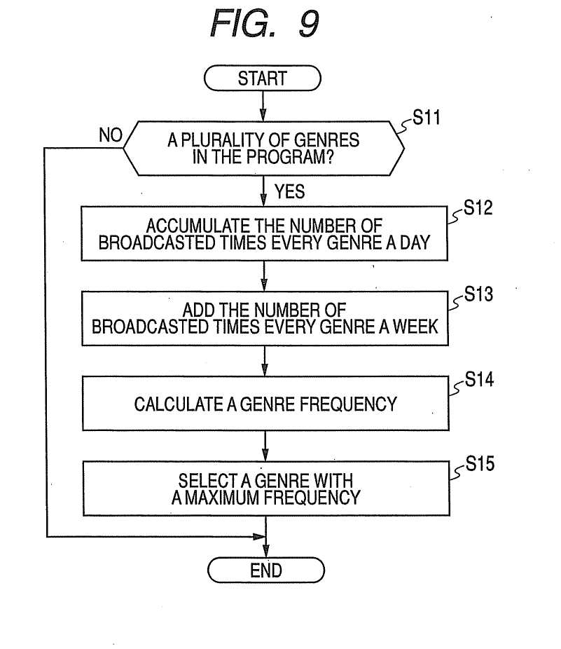

In step S11 shown in FIG. 9, it is checked whether or not there are plural genres of the program. If there are plural genres, the genre-associated broadcasted times accumulating portion 26 counts/accumulates the number of broadcasted times of the programs every genre a day (step S12).

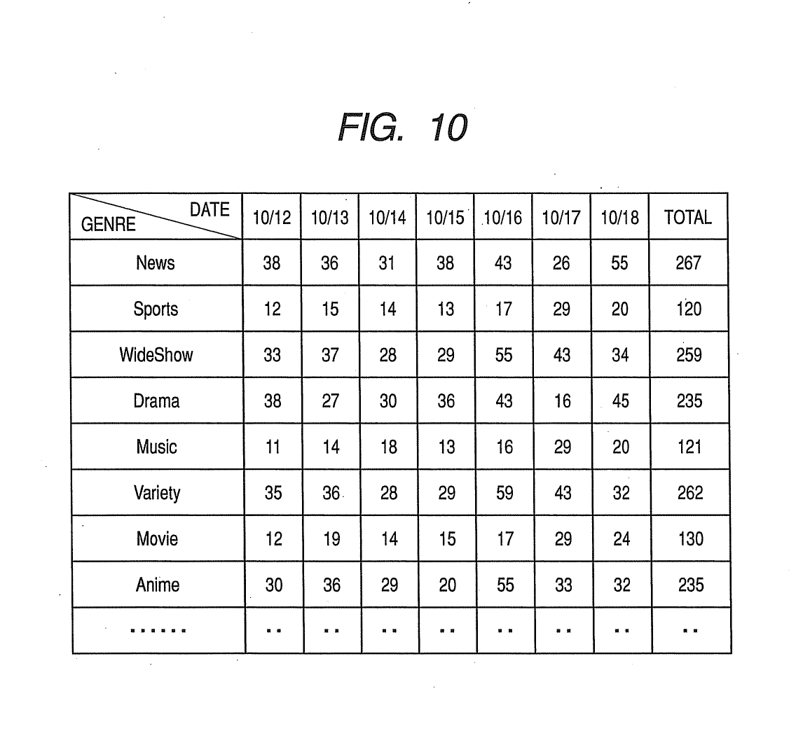

Next, in step S13, the genre-associated broadcasted times adding portion 27 adds the number of broadcasted times every genre for a predetermined term, e.g., one week. An example of the number of times of the broadcasting programs in one week from October 12 to October 18 every genre is shown in FIG. 10. For example, on October 12, the program in the “News” genre was broadcasted 38 times, the program in the “Sports” genre was broadcasted 12 times, and the program in the “Wide Show” genre was broadcasted 33 times. The number of broadcasted times of the programs every genre a day is stored once in the genre-associated broadcasted times accumulating portion 26.

Then, the number of broadcasted times of the programs every genre a day is sent to the genre-associated broadcasted times adding portion 27 and stored therein. The data stored for one week are added genre by genre in the genre-associated broadcasted times adding portion 27. For example, as shown in FIG. 10, the program in the “News” genre was broadcasted 267 times in one week from October 12 to October 18.

Next, in step S14, the genre frequency calculating portion 28 calculates a genre frequency based on the data. Then, in step S15, the genre frequency calculating portion 28 compares the genre frequencies calculated mutually, and selects the genre whose frequency is maximum. The information about the genre selected in this manner is input into the recommended program determining portion 52, and is referred to in generating a recommended program list that is provided to the viewer.

In this case, the case where there are plural genres whose frequencies have the same value may be considered. In such case, the method of selecting these program genres at random, the method of selecting the program that appeared at first, the method of selecting the program that appeared later, etc. may be applied. When the predetermined term is in excess of one week, the number of programs is enormous. Therefore, there is a very small possibility that the genre frequencies have the same value. As a result, even if any one of these program genres is selected in the situation that the genre frequencies have the same value, the general situation will not be affected.

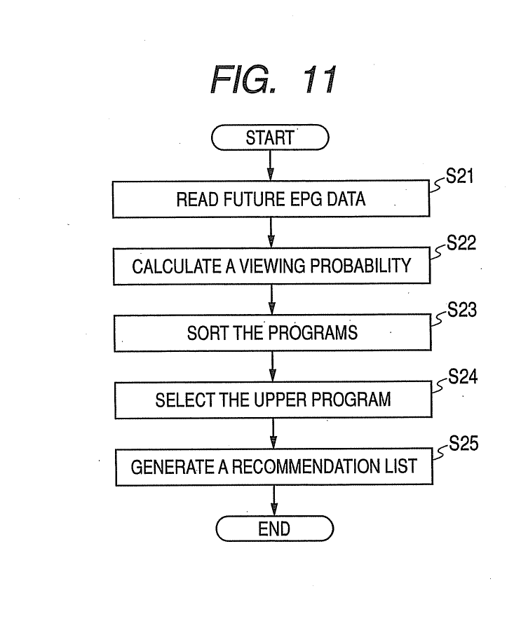

Next, procedures of generating the recommended program list base on the preference list in which probability values defined as above are given will be explained with reference to a flowchart shown in FIG. 11.

The viewing probability calculating portion 51 reads future EPG data from the EPG data managing unit 20 (step S21). The viewing probability calculating portion 51 calculates a viewing probability based on this EPG data and the conditional probability value of the preference model input from the preference model managing portion 42 (step S22).

Then, in step S23, the recommended program determining portion 52 sorts the television programs to be broadcasted in future, based on the viewing probability (concretely, given as a probability value) calculated by the viewing probability calculating portion 51. In step S24, the recommended program determining portion 52 selects the upper program in the ranking as the recommended program data. When plural genres are contained in the television program information, the genre whose frequency is high is selected in this embodiment. The recommended program determining portion 52 decides the recommended program list by taking account of the program genre selected in this manner.

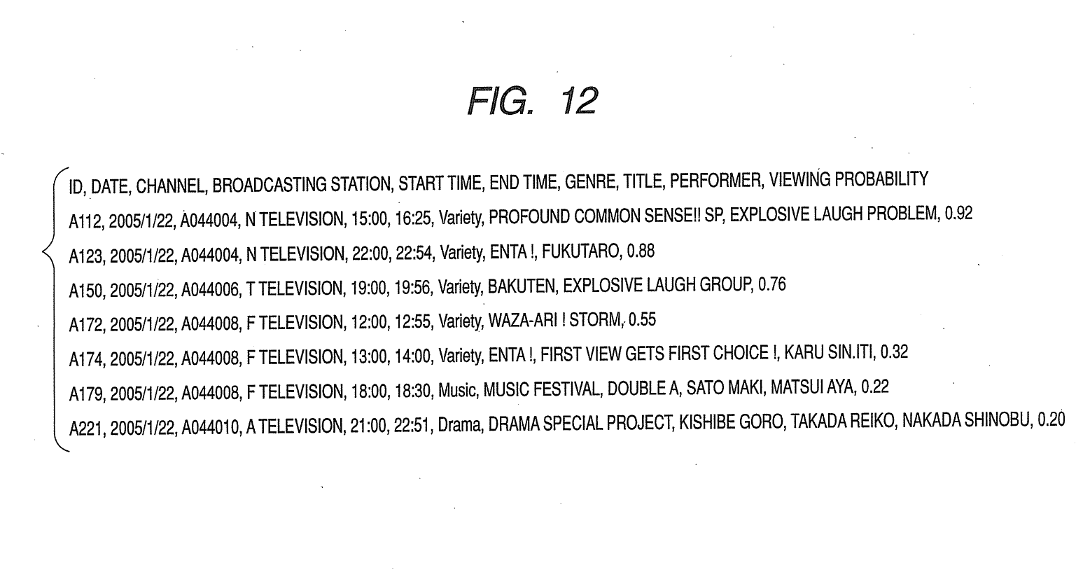

An example of the recommended program data is shown in FIG. 12. FIG. 12 shows an example of recommended program data formed in the embodiment of the present invention. In the example shown in FIG. 12, the probability with which the program “profound common sense!! SP” is viewed by the viewer is highest at 0.92, and such program is presented as the recommended program.

Then, the recommended program data are stored in the EPG data managing unit 20 as a recommendation list (step S25).

In step S24, the method of selecting the upper program in the ranking may be applied variously. In this embodiment, the program whose genre frequency is high is selected as the program recommended in the upper rank.

The viewer interface 10 receives the recommended program data decided by the recommended program determining portion 52 from the EPG data managing unit 20, and the recommended program data are presented as recommended program information.

The first embodiment is based upon such an idea that a feature of the program to be selected is represented by the genre frequency information in a predetermined term as a frequency of the genre becomes higher.

### SECOND EMBODIMENT

In the first embodiment, the genre frequency is calculated and the program having a high genre frequency is selected as the program recommended in the upper rank. On the contrary, in a second embodiment, the program having a low genre frequency calculated is selected as the program recommended in the upper rank. Therefore, in the second embodiment, the genre frequency of the program must be also calculated.

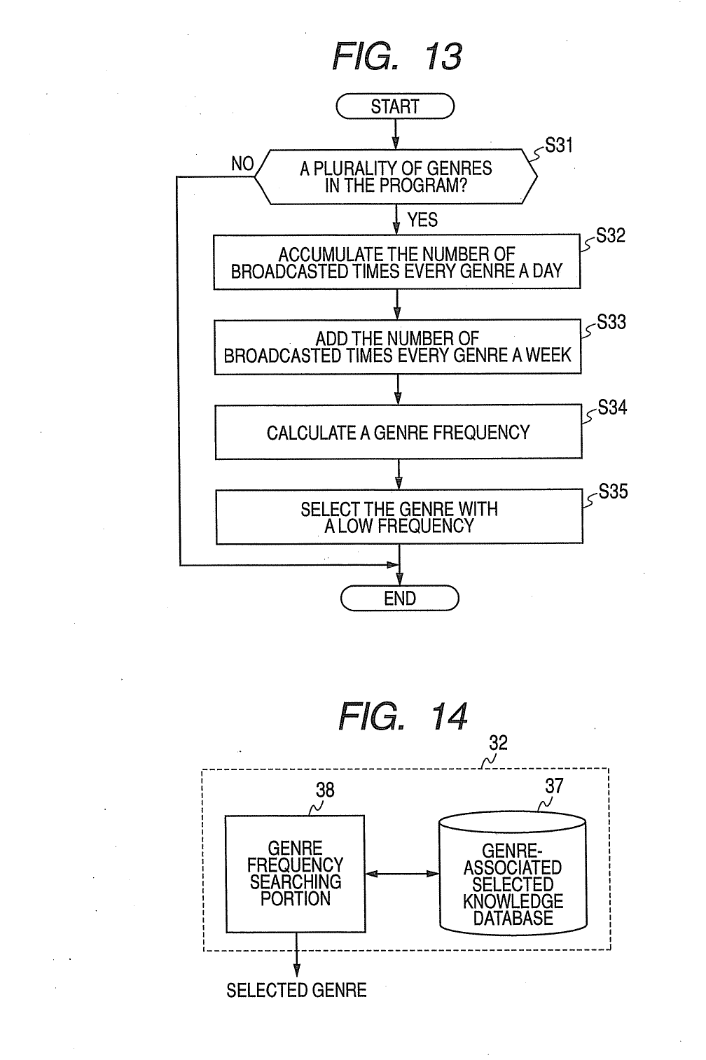

A flowchart of the genre selecting process in the second embodiment is shown in FIG. 13. The genre selecting unit 22 has the same configuration as that in FIG. 2. With respect to the data of the program read from the EPG database 24, the genre-associated broadcasted times accumulating portion 26 accumulates the number of times of the broadcasting program every genre a day (step S32).

Then, the genre-associated broadcasted times adding portion 27 adds the number of times of the broadcasting program every genre for a predetermined term, e.g., one week (step S33). Then, the genre frequency calculating portion 28 calculates a genre frequency based on such number of times (step S34). These processes are similar to those explained with reference to FIG. 10 in the first embodiment.

However, next step S35 is different from step S24 in which the upper program is selected, and the program in the genre whose frequency is low is selected as the program recommended in the upper rank in this Embodiment. The information of the selected program genre is input into the preference model learning portion 41 of the preference model generating unit 40 via the EPG data managing unit 20.

The second embodiment is based upon such an idea that a feature of the program to be selected is represented by the genre frequency information in a predetermined term as a frequency of the genre becomes lower.

### THIRD EMBODIMENT

In the first and second embodiments, the genre frequency is calculated by using the EPG data indicating the broadcasting program information, i.e., based on the genre-associated number of times of the actually broadcasted program.

However, it is found that, when the frequency of each genre of the broadcasting program is watched over some long term, such frequency scarcely varies. Therefore, it is possible to employ a database in which such genre frequencies are compiled into a database as the selective knowledge.

As shown in FIG. 14, a genre selecting unit 32 in the third embodiment has a genre-associated selected knowledge database 37 for storing the frequency of the broadcasting program every genre as the selective knowledge as described above, and a genre frequency searching portion 38 for searching the genre-associated selected knowledge database 37. When a plurality of program genres are contained in the broadcasting program, the viewer selects one program genre by using the selective knowledge stored in the genre-associated selected knowledge database 37. The selected program genre is input into the preference model learning portion 41 via the EPG data managing unit 20.

The third embodiment is based upon such an empirical rule that the actual frequency of the broadcasting program in each genre does not vary in some long term such as one week, or more.

### FOURTH EMBODIMENT

In the first through third embodiments, the recommended program is decided based on the genre frequency of the broadcasting program.

However, the program information providing system may be configured that the recommended genre can be selected based on the structure of the television program information (EPG), e.g., the genre listing position (order of appearance) that the television program information shown in FIG. 6 indicates, not to detect the frequency.

In a fourth embodiment, the firstly appearing genre is selected as the upper genre when plural genres are set forth.

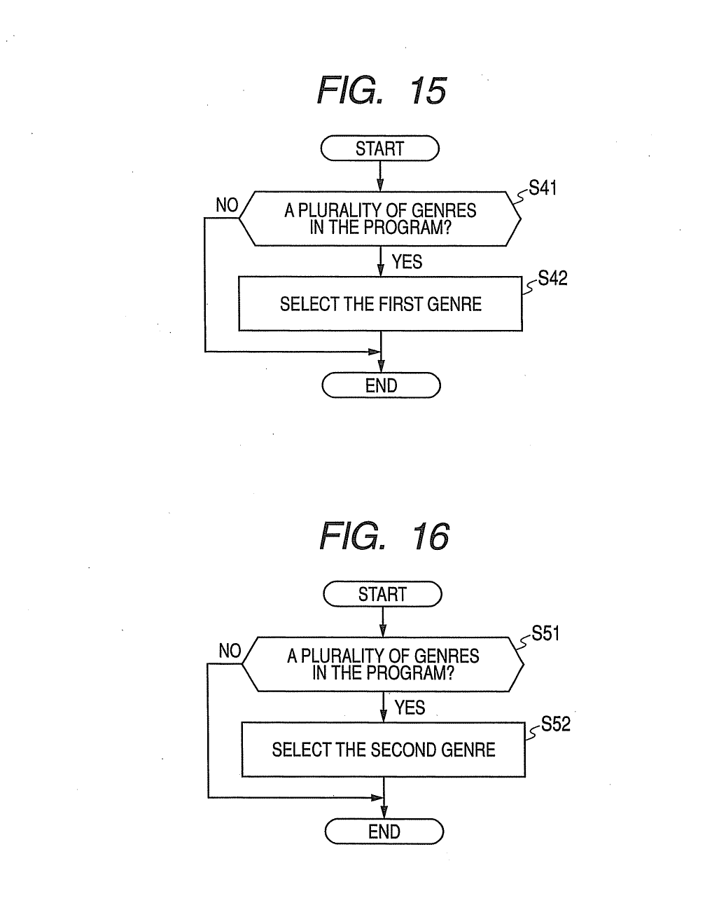

A flowchart of the genre selecting process in the fourth embodiment is shown in FIG. 15. In the fourth embodiment, it is detected in step S41 whether or not plural genres of the program are present. If plural genres are contained in the television program information, the first genre, i.e., firstly appearing genre is selected in step S42. The selected program genre is input into the preference model learning portion 41 via the EPG data managing unit 20.

For example, in the example of the television program information shown in FIG. 6, the “hobby/education” is selected as the genre in the program “Child raising television”

### FIFTH EMBODIMENT

As the method of selecting the genre from the structure of the television program information, the secondly appearing genre can be selected. A flowchart of the genre selecting process according to a fifth embodiment is shown in FIG. 16.

In step S51, it is detected whether or not there are plural genres of the program. If plural genres are detected, the secondly appearing genre is selected in step S52. The selected program genre is input into the preference model learning portion 41 via the EPG data managing unit 20.

For example, in the example of the television program information shown in FIG. 6, the “welfare” is selected as the genre in the program “Child raising television”.

### SIXTH EMBODIMENT

In a sixth embodiment, the thirdly appearing genre is selected as the upper genre when three genres or more are set forth.

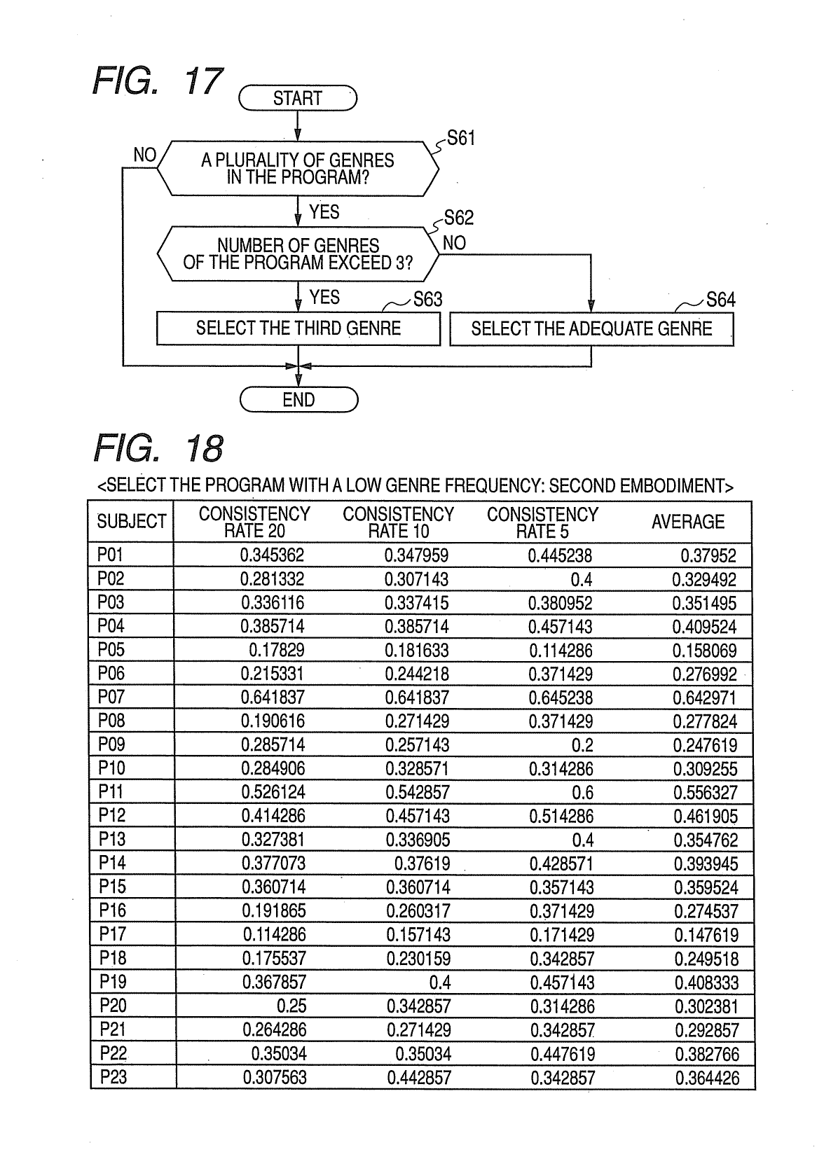

A flowchart of the genre selecting process according to the sixth embodiment is shown in FIG. 17. In the sixth embodiment, it is detected in step S61 whether or not there are plural genres of the program. If plural genres are contained in the television program information, it is detected in step S62 whether or not the number of genres of the program exceeds 3.

If three genres or more of the program are set forth in step S62, the thirdly appearing genre is selected in step S63. In contrast, if the number of genres of the program is 2 in step S62, the adequate genre is selected in step S64. For example, the firstly appearing genre or the secondly appearing genre is selected according to fourth embodiment or fifth embodiment. The selected program genre is input into the preference model learning portion 41 via the EPG data managing unit 20.

### Experimental Result

Experiments are performed for the case of second embodiment in which the genre frequency is calculated and then the program having a small value is selected and for the case of fourth embodiment in which the firstly appearing genre is selected based on the structure of the television program information when plural genres are set forth. The results of the experiments are shown in FIG. 18 to FIG. 20.

The number of test viewers is 23 persons (P1 to P23). A precision and an average of precisions were detected when 20, 10, 5 recommended programs are selected respectively based on the viewing history data collected over seven days in the past.

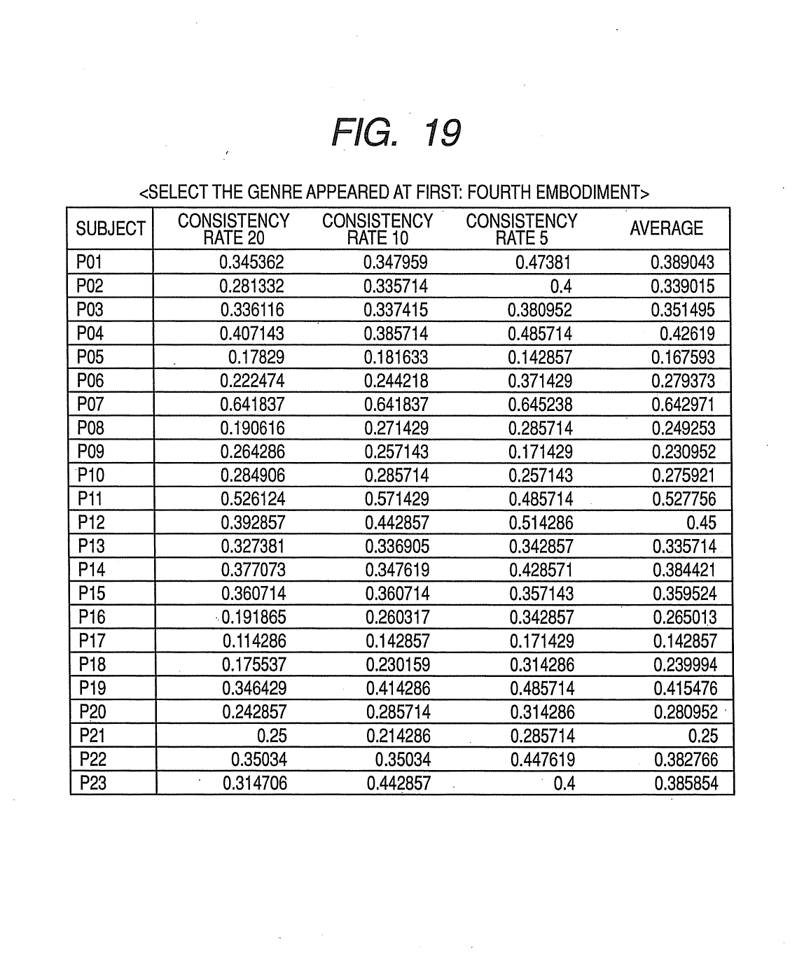

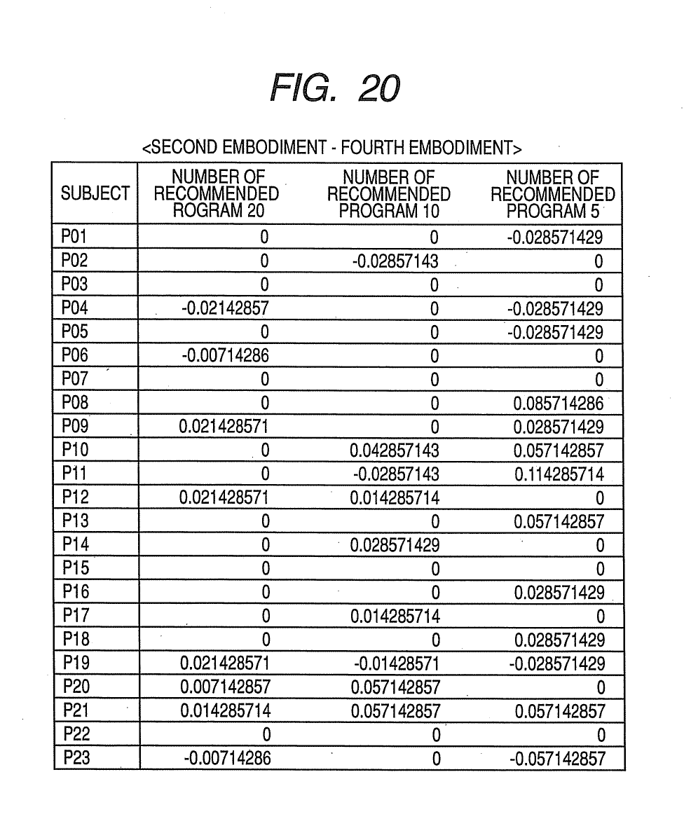

FIG. 18 shows results of the experiment for the second embodiment, FIG. 19 shows results of the experiment for the fourth embodiment, and FIG. 20 shows values of the result obtained by subtracting the precision in fourth embodiment from the precision in second embodiment in individual personal cases.

It is understood that, since positive values are large in number in FIG. 20, the viewer's desired program can be provided more adequately if the case of fourth embodiment in which the firstly appearing genre is selected is used as the genre selecting criterion rather than the case of second embodiment in which the genre frequency is calculated and then the program having a small value is selected.

The present invention is not limited to the above-described embodiments, and the constituent elements can be deformed at the implementing stage within a scope not-departing from the present invention. For example, in the above embodiments, the preference model is updated by the preference model learning portion 41. However, a preference model updating portion for updating the preference model, for example, may be provided separately for this purpose.

In the above-described embodiments, details of the update of the preference model are not mentioned, but the preference model may be updated as follows. First, the preference model managing portion 42 calls the preference model learning portion 41 to update periodically the preference model and also calls the viewing probability calculating portion 51 to update the recommended program list. Then, the preference model and the recommended program list are updated by executing all steps in generating the preference model shown in FIG. 3 and all steps in generating the recommended program list shown in FIG. 12. In this case, they may be updated once a day or once a week as the frequency of update.

Also, the present invention may be implemented in various ways by combining appropriately a plurality of constituent elements disclosed in the above embodiments. For example, several constituent elements may be deleted from all constituent elements disclosed in the above embodiments. Also, the constituent elements of different embodiments may be combined appropriately.

According to the present invention, the recommendation of the program that suits a viewer's own preference is made possible from a relatively initial stage after the viewing is started even when there are a plurality of entries for genres in program information, and also the recommendation of the program that responds flexibly to a change of a viewer's preference is made possible.

It is to be understood that the invention is not limited to the specific embodiment described above and that the present invention can be embodied with the components modified without departing from the spirit and scope of the present invention. The present invention can be embodied in various forms according to appropriate combinations of the components disclosed in the embodiments described above. For example, some components may be deleted from all components shown in the embodiments. Further, the components in different embodiments may be used appropriately in combination.

What is claimed is:

1. A program information providing system comprising:
a genre selecting unit that selects a selected program genre from among a plurality of program genres contained in program information based on a selection criterion obtained from frequency information that indicates frequencies of each of the program genres during a predetermined time period;
a preference model generating unit that generates a preference model describing a causal relationship between a cause leading to a viewing and a viewed result, based on the selected program genre and viewing history information of the viewer; and
a recommended program list generating unit that generates a recommended program list by using the preference model generated by the preference model generating unit.

2. The system according to claim 1, wherein the cause leading to the viewing contains the selected program genre.

3. The system according to claim 1, wherein the selection criterion is to select, as the selected program genre, a program genre having a high frequency.

4. The system according to claim 1, wherein the selection criterion is to select, as the selected program genre, a program genre having a low frequency.

5. The system according to claim 1, wherein the selection criterion is to select a program genre based on a genre-associated selective knowledge database that stores the frequency information for each of the program genres.

6. The system according to claim 1, wherein the preference model generating unit generates a Bayesian network as the preference model, the Bayesian network being determined by defining a conditional probability of a random variable containing the program genre and causal relationships of random variables that are affected by the random variable.

7. The system according to claim 6, wherein the preference model generating unit includes:
a preference model learning portion that generates a Bayesian network type preference model for each viewers; and
a preference model managing portion that develops the preference model by expressing a difference between individual viewers by values in a conditional probability table of respective random variables in the Bayesian network.

8. The system according to claim 1, wherein the recommended program list generating unit includes:
a viewing probability calculating portion that calculates a viewing probability value of the viewer on each of the programs by using the preference model generated by the preference model generating unit; and
a recommended program determining portion that determines the recommended program based on the viewing probability value of the viewer.

9. The system according to claim 8, wherein the recommended program determining portion sorts the programs based on the viewing probability value of the viewer calculated by using the preference model generated by the preference model generating unit, and recommends a program having a higher rank in the sorted result.

10. The system according to claim 1, wherein the preference model generating unit includes a preference model updating portion that periodically updates the preference model.

11. The system according to claim 10, wherein the preference model updating portion updates values in a conditional probability table of respective random variables in a Bayesian network based on the viewing history information for a predetermined time period in the past from a point of the update.

12. A program information providing system comprising:
a genre selecting unit that selects a selected program genre from among a plurality of program genres contained in program information based on a selection criterion obtained from an order of appearance of the program genres in the program information.
a preference model generating unit that generates a preference model describing a causal relationship between a cause leading to a viewing and a viewed result, based on the selected program genre and viewing history information of the viewer; and
a recommended program list generating unit that generates a recommended program list by using the preference model generated by the preference model generating unit.

13. The system according to claim 12, wherein the selection criterion is to select, as the selected program genre, a program genre that is firstly appeared in the program information.

14. The system according to claim 12, wherein the selection criterion is to select, as the selected program genre, a program genre that is secondly appeared in the program information.

15. The system according to claim 12, wherein the selection criterion is to select, as the selected program genre, a program genre that is thirdly appeared in the program information when three or more program genres are contained in the program information.

16. The system according to claim 12, wherein the preference model generating unit generates a Bayesian network as the preference model, the Bayesian network being determined by defining a conditional probability of a random variable containing the program genre and causal relationships of random variables that are affected by the random variable.

17. The system according to claim 16, wherein the preference model generating unit includes:
a preference model learning portion that generates a Bayesian network type preference model for each viewers; and
a preference model managing portion that develops the preference model by expressing a difference between individual viewers by values in a conditional probability table of respective random variables in the Bayesian network.

18. The system according to claim 12, wherein the recommended program list generating unit includes:
a viewing probability calculating portion that calculates a viewing probability value of the viewer on each of the programs by using the preference model generated by the preference model generating unit; and
a recommended program determining portion that determines the recommended program based on the viewing probability value of the viewer.

19. The system according to claim 18, wherein the recommended program determining portion sorts the programs based on the viewing probability value of the viewer calculated by using the preference model generated by the preference model generating unit, and recommends a program having a higher rank in the sorted result.

20. The system according to claim 12, wherein the preference model generating unit includes a preference model updating portion that periodically updates the preference model.

21. The system according to claim 20, wherein the preference model updating portion updates values in a conditional probability table of respective random variables in a Bayesian network based on the viewing history information for a predetermined time period in the past from a point of the update.

22. A method for providing program information, the method comprising:
selecting, when a plurality of program genres are contained in program information, a selected program genre from among the program genres based on a selection criterion obtained from frequency information that indicates frequencies of each of the program genres during a predetermined time period;
generating a preference model that describes a causal relationship between a cause leading to a viewing and a viewed result, based on the selected program genre and viewing history information of the viewer; and
generating a recommended program list by using the preference model generated by the preference model generating unit.

23. A method for providing program information, the method comprising:
selecting, when a plurality of program genres are contained in program information, a selected program genre from among the program genres based on a selection criterion obtained from an order of appearance of the program genre in the program information;
generating a preference model that describes a causal relationship between a cause leading to a viewing and a viewed result, based on the selected program genre and viewing history information of the viewer; and
generating a recommended program list by using the preference model generated by the preference model generating unit.

24. A computer-readable medium containing a program for causing a computer system to operate to perform a process comprising:
selecting, when a plurality of program genres are contained in program information, a selected program genre from among the program genres based on a selection criterion obtained from frequency information that indicates frequencies of each of the program genres during a predetermined time period;
generating a preference model that describes a causal relationship between a cause leading to a viewing and a viewed result, based on the selected program genre and viewing history information of the viewer; and
generating a recommended program list by using the preference model generated by the preference model generating unit.

25. A computer-readable medium containing a program for causing a computer system to operate to perform a process comprising:
selecting, when a plurality of program genres are contained in program information, a selected program genre from among the program genres based on a selection criterion obtained from an order of appearance of the program genre in the program information;
generating a preference model that describes a causal relationship between a cause leading to a viewing and a viewed result, based on the selected program genre and viewing history information of the viewer; and
generating a recommended program list by using the preference model generated by the preference model generating unit.
